(19) United States
(12) Patent Application Publication
(10) Pub. No.: US 2004/0045204 A1
(43) Pub. Date: Mar. 11, 2004

(54) Holographic product labeling method

(76) Inventors: Rosemary Miano, Martinsville, NJ (US); Marian N. Holerca, Highland Park, NJ (US)

Correspondence Address: HARNESS, DICKEY & PIERCE, P.L.C., P.O. BOX 828, BLOOMFIELD HILLS, MI, 48303, US

(21) Appl. No.: 10/413,271

(22) Filed: Apr. 14, 2003

Related U.S. Application Data
(63) Continuation-in-part of application No. 10/236,352, filed on Sep. 6, 2002.

(51) Int. Cl. G09F 3/10; B42D 15/00

(52) U.S. Cl. 40/638; 283/81

(57) ABSTRACT

A holographic product labeling method includes defining a holographic image having content adapted to convey information relating to a product. In another aspect, the method includes providing a substrate encoded with a hologram adapted to render the holographic image. In yet another aspect, the method includes labeling the product with the substrate. Various implementations include use of true and/or multiplex holograms. Use of a transparent holographic substrate and an under label is further explored, as are uses of increased display capability provided to a given region of the holographic label according to the present invention.

### CROSS-REFERENCE TO RELATED APPLICATIONS

This application is a continuation-in-part of U.S. patent application Ser. No. 10/236,352 filed on Sep. 6, 2002. The disclosure of the above application is incorporated herein by reference.

### FIELD OF THE INVENTION

The present invention generally relates to methods for labeling products, and particularly relates to labeling products using true holograms to communicate information about the product to a consumer.

### BACKGROUND OF THE INVENTION

Selling products (especially in a retail environment, also referred to herein as “retail products”), such as personal care products, consumable products, grocery products, and the like, is extremely competitive. Manufacturers of such products typically develop and offer numerous different configurations, formulations, flavors, colors, and packaging of their products, in an effort to appeal to broader market segments and, therefore, capture greater market share. The creation of appropriate and appealing product labels is the basis of intense work in design and study of advertisement.

The variety of products available for a given category can create an extremely competitive environment for a vendor who is trying to distinguish its products either at the wholesale or retail level. Thus, any advantage in product appearance becomes important to the vendor as part of the process of getting the purchaser to choose that vendor's products.

Advertisements are used either in-store or in the media (television, radio, Internet), but a product's appearance can be compelling at the actual point of sale. Of special concern are products that are easily confused such as antiperspirants, shampoos, hair care products, toothpaste, toothbrushes, mouth rinses, detergents, and cleaning products for household use. Many of these products in a given category are hard to differentiate because of similarity in packaging due to shape and/or color. For example, many antiperspirants are in oval containers with clear, pastel or white packaging even though there are a variety of choices such as sticks, gels, and soft solids, to name a few. Selling efficiency is very important and a product that sits unsold on the shelf is a product quickly discarded for better selling products. Product manufacturers understand this importance, and strive to make their product packaging and display material as informative as possible.

In a retail environment, for example, where consumer products, such as personal care products, consumable products, grocery products, and the like are sold, the average consumer makes his or her purchasing decision in a short period of time. For example, one study has found that the length of time that a shopper spends at the shelf looking for an antiperspirant/deodorant product is in the range of 52-69 seconds. They either select a product or leave without a product. Another study has found that shoppers make 40-60% of their buying decisions while standing in front of the shelf. That means that any in-store marketing material, packaging, or display information must preferably communicate the benefits of the product or some distinguishing feature in as short a time as possible and, preferably in less than 60 seconds (more preferably within 30 seconds). This efficient communication becomes particularly hard to perform where the choices are many and where the difference among products are subtle or sophisticated. Imagine, for example, communicating in a period of 60 seconds or less, the differences among several different types of antiperspirant/deodorant products that may have different fragrances, product forms, specific benefits (aloe, vitamins), and applicator technology (stick, roll-on, gel) or offer other selling features, such as “dries quickly” or “leaves no residue on clothing”. Communicating these differences in a retail environment to the busy, time-crunched consumer is indeed a very challenging problem.

The aforementioned challenges are further complicated by the ever increasing need to communicate more information in labels to consumers; increasing Food and Drug Administration requirements for information are just one example. The need to communicate various types of information, such as product identity, manufacturer, use, instructions for use, ingredients, precautions, disclaimers, and emergency response, perhaps even in multiple languages, remains at odds with the need to conserve shelf space by substantially minimizing the size of the product container, thereby reducing available labeling area. These competing needs are deeply felt when attempting to label, for example, health and beauty products, which can be relatively small in size, but have relatively large requirements for communication of various types of information in one or more ways. As a result, there is a need for a product label that has the ability to attract consumers' attention, swiftly identify the labeled product and its uses, swiftly distinguish it from other products of similar use, appearance, and/or location, and further have an increased ability to communicate useful and/or aesthetic information.

### SUMMARY OF THE INVENTION

In accordance with the present invention, a holographic product labeling method includes defining a holographic image having content adapted to convey information relating to a product. In another aspect, the method includes providing a substrate encoded with a hologram adapted to render the holographic image. In yet another aspect, the method includes labeling the product with the substrate.

The present invention is advantageous over previous product labels. For example, the inventive labeling method can be implemented to provide a more eye-catching display to enhance the appeal of the product or a carton in which the product is packaged, such as at the wholesale level. This increased appeal is one benefit that works well with the short attention span of busy and sometimes confused purchasers to both attract consumer's attention and swiftly communicate information.

Also, the inventive labeling method can be implemented to communicate increased amounts of information to consumers in a given amount of label space. Use of a hologram encoded in a transparent substrate, for example, permits a consumer to view the holographic image from one angle, while also allowing the consumer to view another, non-holographic image disposed beneath the hologram from another angle, thereby multiplying an amount of information that can be conveyed in a given area and/or improving the appearance of the labeled product.

Further, multiple holographic images viewable from different angles can be encoded in a given portion of the substrate, thereby multiplying an amount of information that can be conveyed by the hologram and/or improving the appearance of the labeled product. Yet further advantages and areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective view of a labeled product container showing a conventional opaque label with an overlay of transparent film on which has been created a true hologram;

FIG. 2 is a perspective view of labeled products on display in a retail environment in accordance with the present invention; and

FIG. 3 is a graph depicting ranges of viewing angles for holographic and non-holographic lighting;

FIG. 4 is an exploded perspective view of a labeled product container providing multiple viewing angles and labeled with substantially transparent hologram encoded substrates in accordance with the present invention;

FIG. 5 is a block diagram depicting plural views of the labeled product container of FIG. 4, wherein the holograms are encoded within a relatively narrow range of viewing angles that are viewable substantially without dependence on holographic lighting conditions in accordance with the present invention;

FIG. 6 is a block diagram depicting plural views of the labeled product container of FIG. 4, wherein the holograms are encoded within a relatively wide range of viewing angles, wherein at least part of the range is dependent on holographic lighting conditions in accordance with the present invention;

FIG. 7 is a graph depicting multiple holographic images encoded in a given region of a substrate and viewable from different angles in accordance with the present invention;

FIG. 8 is a graph depicting combination of multiple substrate regions to create a perspective-dependent product appearance in accordance with the present invention;

FIG. 9 is a graph depicting a perspective-dependent product appearance in accordance with the present invention;

FIGS. 10A-10C are perspective views of a labeled product demonstrating change in product appearance with change in perspective in accordance with the present invention; and

FIG. 11 is a perspective view of a labeled product in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses. In a first embodiment, a holographic label is created which includes a flat or slightly curved container to which has previously been applied a conventional opaque label (such as a paper or plastic label adhered to the surface with glue or adhesive or a hot stamped or paint screened image), and a transparent film on which has been created a true hologram.

There are alternative sub-embodiments of the first embodiment that vary according to how the two-dimensional image provided by the conventional opaque label and the three-dimensional image provided by the true hologram are used together. For example, one embodiment includes the creation of a label with the holographic portion providing essentially the same image as the image on the conventional label. In this embodiment, the three-dimensional image can be situated to obscure the two-dimensional image when visible, so that it effectively replaces the two-dimensional image when viewed from a suitable perspective. In another embodiment, the holographic image is supplemental to the image on the conventional label, and may partially obscure or simply add to the conventional image when viewed from a suitable perspective. In a still further embodiment, the holographic image is substantially different than the image on the conventional label, and can replace and/or supplement the conventional image according to various alternative implementations.

In practicing the method of the first embodiment of the present invention, a type of true hologram known as a reflection hologram may be used. The so-called true hologram differs from the more commonly seen, mass produced holograms employed on credit cards to deter forgery. The true hologram produces the visual experience of looking at a three-dimensional object by creating a wavefront of light that produces the appearance of a three-dimensional image at least partially in front of the plane of the hologram plate used to produce it. The 3D holographic image is produced by constructive and destructive interference of the light rays that make up the wavefront.

There are several techniques for producing a 3D holographic image using a true hologram. In the case of the first embodiment, a true hologram known as a “reflection hologram” may be used. A reflection hologram employs a hologram plate or film with a reflective layer, and a light source positioned on the same side of the plate as the viewer. Viewing the image from a reflection hologram is like looking at an object or image that is floating in space. The image may be located anywhere along the line of sight axis. The hologram plate can be configured so that the image appears to be rendered fully in front of the plane of the hologram plate or fully in back of the plate. Alternatively, the hologram plate can be configured so that the image is only partially rendered in front of the plate or partially in back of the plate.

In most applications of the first embodiment in a retail environment, reflection hologram technology using a white light source, such as from a bright halogen lamp, positioned to cast light upon the row of products with the film label portion and without obstruction or shadow is preferred. This may be done by placing one or more lights directly in front of the product display or slightly to the side as long as the holographic image is viewable. Optionally the light may be placed more to the side or behind the product label with an appropriately oriented mirrored surface for reflecting the light onto the container label.

If it is desired to display a product feature or selling point that involves a moving part, or where the feature is best exemplified by movement or a moving metaphor, the hologram image may be configured to produce animated effects. This can be done by a variety of different techniques. One technique employs a “multiplex hologram” in which images are developed from several angles onto the same hologram plate or film. When the viewer moves from one vantage point to another, such as by moving slightly from side to side, the holographic image appears to move as different ones of the images come into view. The flexing head of a bendable toothbrush may be demonstrated in this fashion. As the viewer moves from side to side (or manipulates the product to similarly alter viewing angle), the rendered holographic image of the toothbrush appears to flex back and forth. For the underarm category, a product can be shown to move across a black cloth to demonstrate no white residue. Obviously the space limitations of the individual container must be considered.

Suitable equipment may be selected from a variety of sources including DuPont, Wilmington, Del.; Krystal Holographics, Inc., New York, N.Y.; Dai Nippon Printing Co., Ltd., Japan; and Zebra Imaging, Inc., Austin, Tex. Of special interest as technology for producing high quality true holograms is available from Zebra Technologies, and is referred to as a “Zebra”. According to Zebra Technologies: A Zebra is, in essence, one large hologram made up of lots of small ones. The process starts with a digital image, which may be generated by a motion-controlled camera or computer graphics software. Like conventional holography, the Zebra process splits and recombines laser light, only the “object” sub-beam is directed through a sequence of digital images on a liquid-crystal screen rather than reflected off a real object. Each resulting exposure, about two millimeters square, is called a “hogel”—the full-color holographic building blocks of a finished Zebra image. In a fully-automated step-and-repeat fashion, hogels are then printed on a flat, square tile of polymer film, which needs no chemical processing. Each two-foot-square tile houses tens of thousands of unique hogels, and each tile can be butted up against another to form high-quality holographic images of unlimited size.

The present invention may use a true hologram, such as a “Zebra”, to construct the label of the invention to generate the 3D image to communicate an appearance feature, a functional feature, an associated characteristic, and/or a method of use of the product. Examples of an appearance feature can be the color of the container, the color of the product, label design or shape of the container. Examples of a functional feature can be form (such as stick, cream or gel), low residue property, non-tacky property, flexible parts and smoothness upon application. Examples of an associated characteristic include fragrance, flavor, emotional state of user, sensorial experience, and environmental metaphors (for example, lightening for power). Examples of method of use include demonstrating application of product. The 3D image is also designed to show and/or efficiently and effectively differentiate multiple, confusing products from one another in a retail environment.

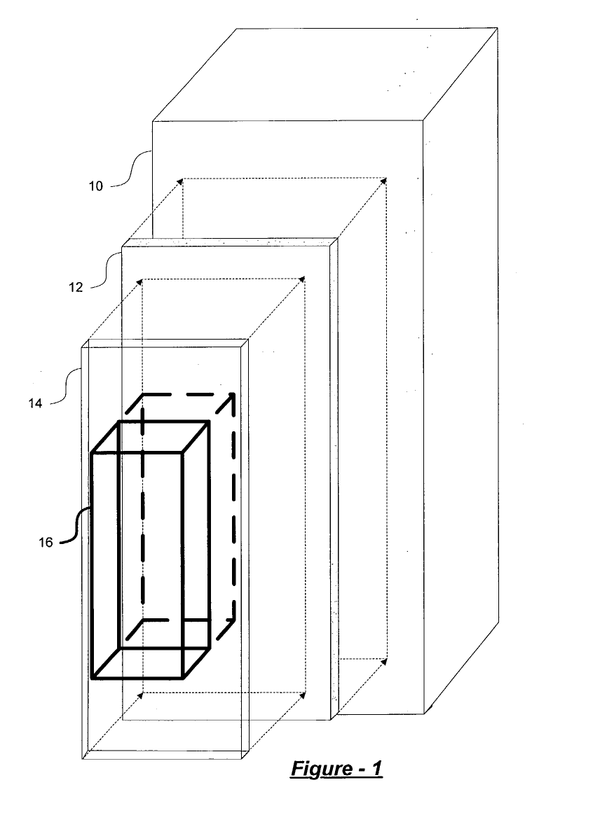

FIG. 1 illustrates a product container 10 on which is found a base label 12 corresponding to an opaque substrate providing a two-dimensional image that conveys information about the product. The container may house an individual product or multiple units of product. Base label 12 may be a separate label which as been applied with adhesive to the surface of the container or an image which has been painted or hot stamped onto the container. Over the base label 12 is positioned a transparent substrate 14, such as a film, on which has previously been constructed a true hologram that renders an image in a three-dimensional space 16 viewable with an appropriate light source (not shown) such as halogen, laser, or even sunlight light source. Container 10 labeled with base label 12 and transparent substrate 14 is hereafter referred to as a labeled product container.

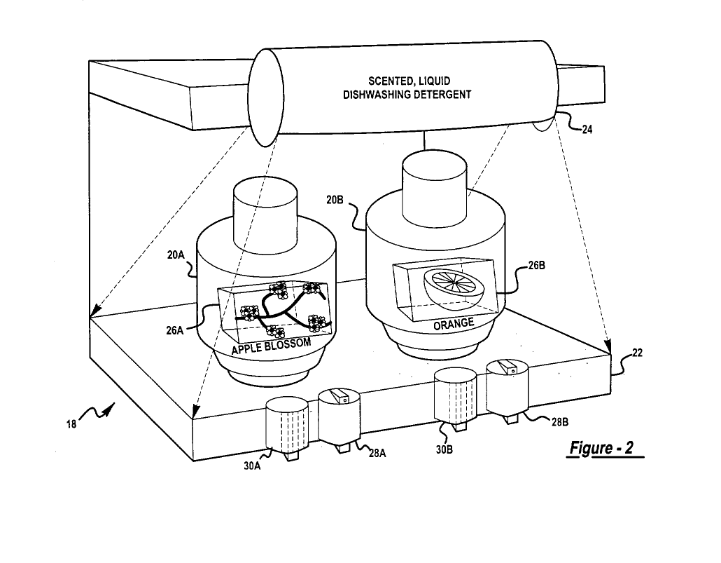

FIG. 2 shows a retail environment 18 in which labeled product containers 20A and 20B are displayed. Containers 20A and 20B are positioned on shelf 22 with holographic light source 24 or series of light sources positioned so that the holographic images 26A and 26B are viewable by a potential purchaser. The light source may be located, for example, at a distance of no more than 15 meters from the label, and preferably no more than 3 meters from the label. Preferably, the 3D image is viewable from a location that accommodates customer traffic flow so as to be readily viewable by the potential customer.

A product image or information about the product is communicated to the potential customer via the generated 3D image. This communication essentially entails designing the true hologram ahead of time to generate a 3D image that communicates information about the product. According to one aspect of the present invention, information communicated about the product relates to specific information, for example, a functional feature and/or associated characteristic of the product. For example, displaying a 3D image of a toothbrush flexing at a particular point in a specific direction with a given range communicates a functional feature of the product. Further, displaying an image of nature in spring to communicate that a detergent has a spring scent communicates an associated characteristic that the product possesses. Thus, a 3D visual image can serve as a metaphor for a non-visual characteristic of a product. Information about the product is preferably communicated to the potential purchaser in a time frame of less than or equal to 60 seconds (more preferably not exceeding 30 seconds) and is based on the activities and maturity of a typical consumer over 18 years of age.

According to another aspect of the present invention, information communicated about the product serves to differentiate the featured product from one or more confusing or competing products, and additional, optional steps may be employed to enhance the present invention in relation to either and/or both of the aforementioned aspects. For example, if multiple confusing products are provided, design of the true hologram is affected to differentiate the target product from other, confusing or competing products. For example, antiperspirant packaging frequently uses similar shapes in a small variety of colors, wherein color designation is not clearly coded to the product. Accordingly, a label of this invention may be used to distinguish among various forms and features of a selection of antiperspirants/deodorants.

Another example of an optional variation on the invention relates to use of additional sensory enhancements to supplement the hologram. For example, active and/or passive fragrance delivery mechanisms 28A and 28B and/or sound delivery mechanisms 30A and 30B can be employed to enhance the experience enjoyed by the potential purchaser. Similarly, a scented patch (not shown) may be positioned on the product container as part of product container 20A and/or 20B. Further, one or more additional true holograms can be used on the same container, such as on a cap of the product container.

There are various alternative embodiments of the present invention. For example, the hologram encoded substrate may be applied directly to the product, directly to a product container, or directly to a label. Also, the hologram encoded substrate may be substantially transparent to allow the product and/or an under label to be viewable from a given perspective. Further, the substrate may bear both a hologram and non-holographic information; one example is a transparent label with two-dimensional text in one portion, a void space for viewing the product, and a hologram encoded into the void space. Still further, the substrate may be attached permanently or temporarily; thus, the hologram may be capable of being peeled and even re-attached to another surface, such as a bathroom mirror, so that the information conveyed by the hologram is conveniently accessible to the consumer.

The type of information conveyed by the image can further vary. For example, the information may relate to identity of the product, identity of a manufacturer of the product, identification of a use of the product; identification of a feature of the product, and/or identification of a characteristic of the product. Also, the information may relate to instructions for using the product, identification of product ingredients, safety precautions applicable to use of the product, and/or legal notices binding a user of the product.

The content of the holographic image may be selected to increase visual appeal by decreasing intrusion of required information upon a consumer, and/or additionally or alternatively selected to increase amount of useful and/or required information communicated to a consumer via a given area of the substrate. This selection capability is realized at least in part by the ability to use the hologram to provide plural product appearances provided by a given area. For example, a multiplex hologram may be used to render multiple holographic images viewable from different angles. Also, using a substantially transparent hologram encoded substrate to overlay information encoded underneath the substrate can be employed; inscribing a text or image in reverse on the underside of the substantially transparent substrate is one example.

The multiple images viewable from different angles and provided to the same region of the label can further be exploited in multiple ways. For example, the multiple images may be of substantially identical content from substantially different perspectives, thereby achieving a three-dimensional appearance for a seemingly still image. Also, the multiple images can be of substantially different content, but substantially similar subject matter, and thereby achieve an animation effect using the multiple images. Further, the multiple images can be of substantially different content, and substantially different subject matter, thereby increasing an amount of information communicated to a consumer via a given area of the label. As a result, the hologram encoded can be a true hologram, a multiplex hologram, or a two-dimensional image that is only viewable from a given perspective.

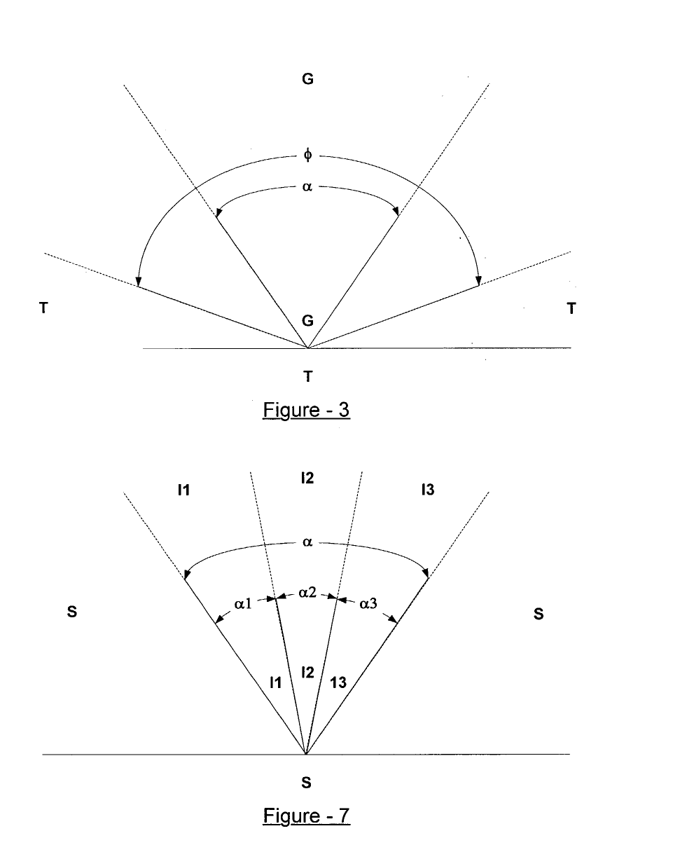

The ability of the hologram to convey information about a product is related to viewing angle, which is to some degree dependent on presence of holographic lighting. FIG. 3 demonstrates a relatively wide range of viewing angles φ and a relatively narrow range of viewing angles α. The relatively narrow range of viewing angles a constitute a “sweet spot” for encoding a hologram that is viewable in non-holographic (diffused) lighting. In contrast, the additional set of angles in α not present in α are subject to low resolution in non-holographic lighting, but are well-resolved in holographic (high intensity, point source) lighting such as halogen light, sunlight, laser, or an intense spotlight. Today's technology typically provides a maximum horizontal range φ of about one-hundred twenty degrees, and a range α of about seventy degrees, while vertical ranges are usually slightly narrower. Use of multiple holograms or use of techniques that exploit different rendering angles can increase the limits of these ranges. Also, current developments of the holographic technology suggest that in the future these limits will be surpassed. A hologram G encoded solely into angles α is therefore viewable in any light, but has a reduced three-dimensional appearance compared to a hologram encoded in angles φ and viewed in holographic lighting.

The viewing experience is dependent on lighting conditions, whether the hologram is encoded in φ or solely in α, and whether the substrate is substantially transparent or opaque. For example, for a hologram encoded solely in α in a transparent substrate, a viewer (not shown) who changes his or her vantage point horizontally sees the hologram G from a perspective situated less than thirty-five degrees to the normal, and sees underlying information T from a perspective situated more than thirty-five degrees to the normal regardless of whether holographic lighting is available; if the substrate is opaque, however, the viewer sees blackness from a perspective situated more than thirty-five degrees to the normal. Also, for a hologram encoded in φ in a transparent substrate in holographic lighting conditions, a viewer sees the hologram G from a perspective situated less than sixty degrees to the normal, and sees underlying information T from a perspective situated more than sixty degrees to the normal; for an opaque substrate, the viewer sees blackness from a perspective situated greater than sixty degrees to the normal. Further, for a hologram encoded in φ in a transparent substrate in non-holographic lighting conditions, a viewer sees a partial image of the hologram G from a perspective situated less than thirty-five degrees to the normal, sees a blurred and/or smeared partial image of G from a perspective situated more than thirty-five degrees to the normal and less than sixty-degrees to the normal, and sees underlying information T from a perspective situated more than sixty degrees to the normal; if the substrate is opaque, the viewer sees blackness from a perspective situated more than sixty degrees to the normal.

FIG. 4 illustrates a hexagonally, cylindrically shaped product container 36 with angled surfaces providing different viewing angles. Under label content U, V, W, X, Y, and Z are provided to surfaces of product container 36, and it should be understood that content X, Y, and Z are provided to surfaces facing away from a viewer having the perspective illustrated in FIG. 4. Transparent substrates bearing hologram content A, B, C, D, E, and F are disposed to overlay the respective under label content U, V, W, X, Y, and Z.

As a result of this arrangement of container surfaces, a viewer of a surface from a direct perspective corresponding to the normal, as with surface 38 in the perspective view provided by FIG. 4, has a view of two adjacent surfaces, as with surfaces 40A and 40B, angled approximately sixty degrees to the normal. Also, it should be readily understood that a viewer of a surface from a perspective providing a view of the surface angled sixty degrees to the normal also has a view of an adjacent surface angled sixty degrees to the normal. It should further be readily understood that the appearance of the product container changes based on the perspective from which it is viewed, and that the appearance may vary depending on how the hologram has been encoded (the predetermined viewing angles) into the substrates, and whether holographic lighting conditions are present.

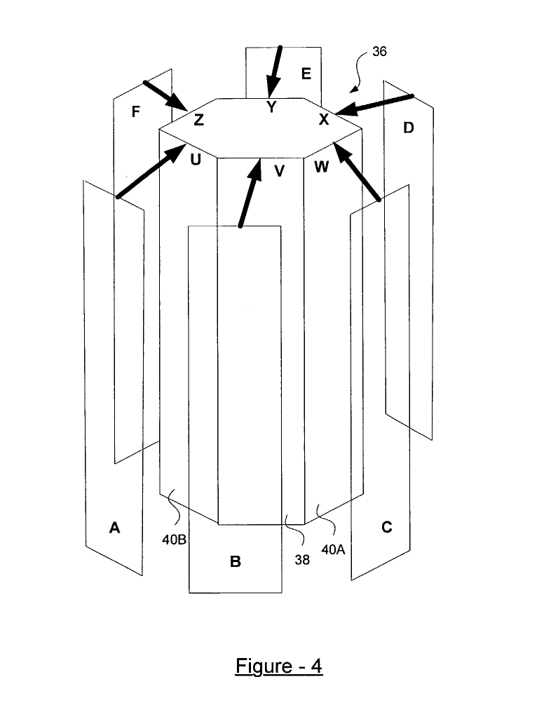

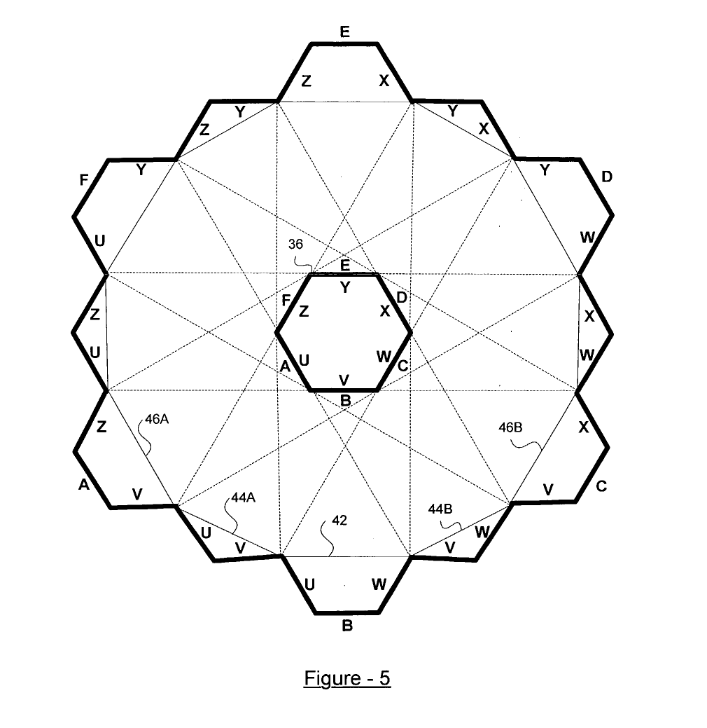

FIG. 5 illustrates various views of the product container 36 wherein the holograms are encoded within a relatively narrow range of viewing angles that are viewable substantially without dependence on holographic lighting conditions in accordance with the present invention. Accordingly, the holograms having content A, B, and C, for example, are encoded to be viewable from an angle not more than thirty-five degrees to the normal. As a result, holographic content B is viewable from perspective 42, as are under label contents U and W from adjacent surfaces. It should be readily understood that under label content V might also be viewable from perspective 42 if holographic content B is arranged so as not to overlay under label content V. However, even where under label content V is obscured by holographic content B at perspective 42, content V is still viewable from perspectives 44A and 44B, and also from perspectives 46A and 46B. As a further result, the amount of information conveyed by the surface bearing under label content V and holographic content B is increased, and various uses can be made of this increased display capability, such as increased conveyance of useful information and/or increased conveyance of aesthetic information.

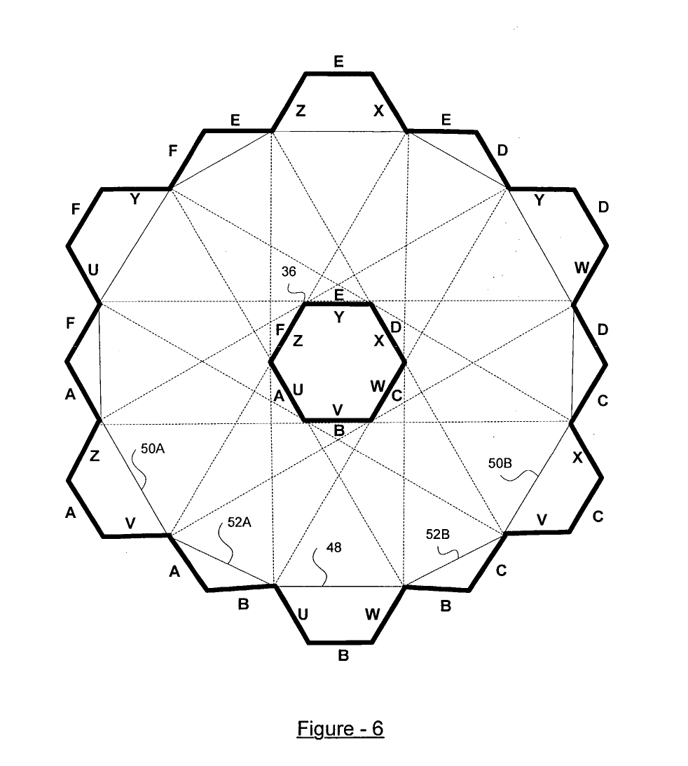

FIG. 6 illustrates various views of labeled product container 36, wherein the holograms are encoded within a relatively wide range of viewing angles, wherein at least part of the range is dependent on holographic lighting conditions in accordance with the present invention. Accordingly, the holograms having content A, B, and C, for example, are encoded to be viewable from an angle up to sixty-degrees to the normal. As a result, holographic content B is viewable from perspective 48, as are under label contents U and W from adjacent surfaces. It should be readily understood that under label content V might also be viewable from perspective 48 if holographic content B is arranged so as not to overlay under label content V. However, even where under label content V is obscured by holographic content B at perspective 48, content V is still viewable from perspectives 50A and 50B.

Appearances of container 36 from perspectives 52A and 52B, however, depend on whether holographic lighting conditions are present. If the holographic lighting is present, then the holographic content B is viewable. However, if the holographic lighting is not present, then a more or less blurred and/or smeared image of content B is viewed. Thus, the amount of information conveyed by the surface bearing under label content V and holographic content B is still increased, and the potential for increased holographic content viewing in holographic lighting conditions is also provided. Improved three dimensional appearance can therefore be obtained for the holographic content in some circumstances, but at the expense of decreased viewing perspectives for under label contents. There also exists, however, the opportunity to increase the number of types of holographic content encoded in a given area.

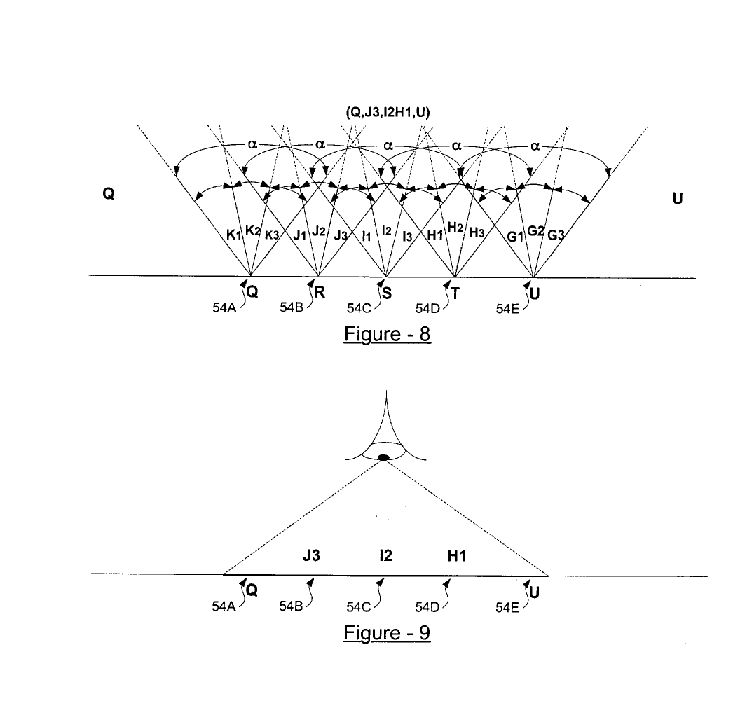

FIG. 7 illustrates multiple holographic images encoded in a given region of a substrate and viewable from different angles in accordance with the present invention. Accordingly, holographic content I1 is viewable from the perspective described by angle α1; holographic content I2 is viewable from the perspective described by angle α2, and holographic content I3 is viewable from the perspective described by angle α3. Further, under label content S is viewable form angles not included in α. Aggregated multiplex holograms of this nature can be disposed in substrate regions 54A-54E according to the present invention as illustrated in FIG. 8. Accordingly, perspective (Q,J3,I2,H1,U) conveys an appearance as illustrated in FIG. 9, wherein holographic content I2 is viewed at central substrate region 54C, holographic contents J2 and H2 are viewed at substrate regions 54B and 54D adjacent to central substrate region 54C, and under label contents Q and U are viewed at substrate regions 54A and 54E beyond adjacent regions 54B and 54D. The angles selected for encoding various portions of the holographic contents can be determined based on curvature of the substrate as desired, and various curvatures can thus be accommodated.

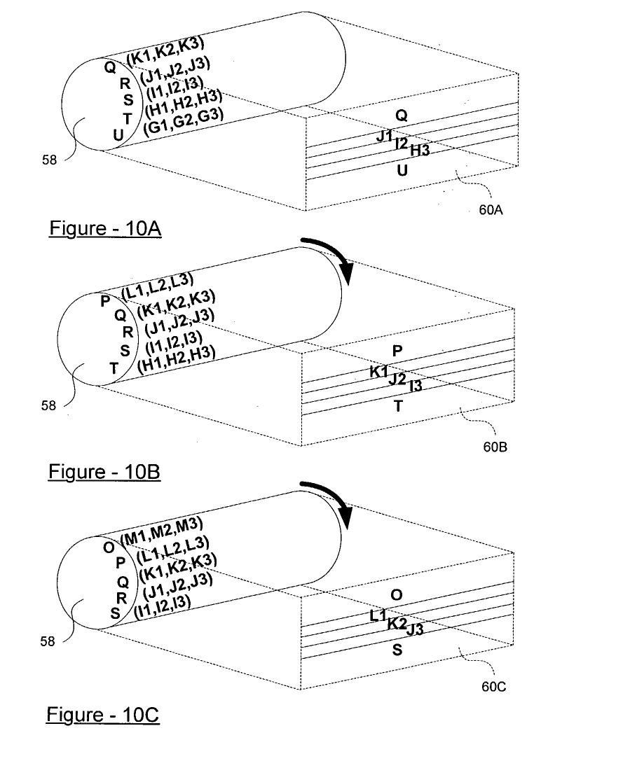

FIGS. 10A-10C provide perspective views of a labeled, cylindrically-shaped product demonstrating change in product appearance with change in perspective in accordance with the present invention. The labeled, cylindrical product 58 is viewed from perspective 60A with views of thin bands of holographic content J1, I2, and H3 in a central region, and wide views of under label content Q and U adjacent to the central region. Viewed contents of the regions change as product 58 is rotated as shown at perspective 60B of FIG. 10B, and as further shown at perspective 60C of FIG. 10C.

An arrangement of holographic content according to FIGS. 10A-10C can be obtained, for example, by employing a cylindrically-shaped hologram plate to encode three labels from different angles into the plate while rotating the cylinder and raster scanning the labels by moving the labels in the slow scanning direction complementary to rotation of the cylindrical hologram plate. The resulting master hologram can then be used to encode the desired hologram into a flat, transparent substrate, and the encoded transparent substrate and under label can then be applied to the cylindrical product. Alternative methods of manufacture include encoding thin, oblong hologram plates with portions of the three labels from different angles and using the plates to develop one or several holographic substrates for application to the product. Other methods will be further apparent to those skilled in the art. Variation of the above methods for various shapes of products, containers, and packages will further be readily apparent to those skilled in the art.

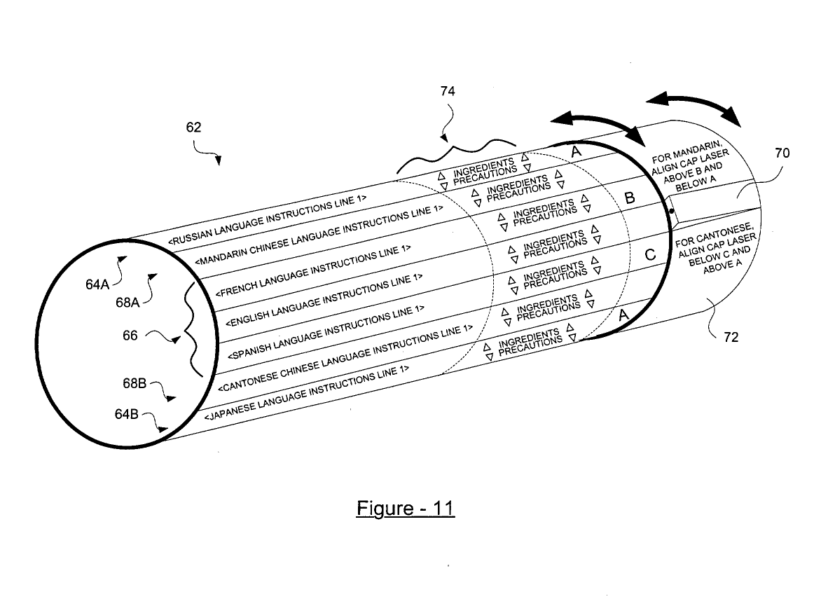

FIG. 11 is a perspective view of a labeled product in accordance with the present invention. Therein, a choice has been made to encode the transparent substrate with five bands of holographic content and to employ regions requiring holographic lighting conditions to increase the amount of information conveyed in a given substrate region. A choice has also been made to encode each region with a line of instructions for using the product, wherein each line is identical in content, but different in language. Russian and Japanese language instructions are provided in different regions 64A and 64B of the under label, while French, English, and Spanish instructions are provided in the central holographic band region 66 viewable regardless of whether holographic lighting conditions are available.

Mandarin and Cantonese Chinese language instructions, however, are provided in the holographic regions 68A and 68B requiring holographic lighting conditions. Therefore, a laser 70 is provided to a mobile cap 72, along with instructions in the appropriate Chinese dialects for training the laser on the appropriate band regions. It should be readily understood that further instructions can be employed for viewing the Chinese dialects in sunlight, and that this option can further be employed as an alternative to providing laser 70. Reference characters A, B, and C are further provided in the under label and holographic bands to assist in operating laser 70.

Further contents not shown in FIG. 11 but provided in the under label and holographic images include subsequent lines of instructions in the various languages, lines of ingredients in the various languages, precautions in the various languages, and other types of information as desired. Accordingly, the defined bands of holographic and under label contents are also provided with an index 74 for navigating the holographic label by indicating a type of information, such as ingredients and precautions, available for viewing by rotating the product in an indicated direction. It should be readily apparent that the holographic label according to the present invention provides a user interface that greatly multiplies an amount of information conveyed to a consumer by a given region of the label. It should further be readily understood that the holographic encoding can further be accomplished so that the appearance of the product changes by rotating it horizontally as well as vertically; thus, the amount of information conveyed can be increased even further in accordance with the present invention.

From the foregoing description, it can be extrapolated that aspects of the present invention can be expanded, combined, and/or alternatively implemented in a number of ways. In particular, the method of the present invention can be implemented in various ways according to various market forces including the needs of the consumer, product type and characteristics, legislative requirements, and/or goals of the product manufacturer. Thus, a label can be achieved as above that can be used in many countries and/or can be used in a multi-lingual environment. Also, a label can be achieved that obtains an improved aesthetic appearance from every perspective by providing aesthetic information to every perspective, while concentrating non-aesthetic, but useful, information into a given label region and rendering it viewable only from limited angles in a way that does not detract from the aesthetic appearance of the product. Further, alternative uses of the holographic labeling method according to the present invention will be readily apparent to those skilled in the art. Moreover, the description of the invention is merely exemplary in nature and, thus, variations that do not depart from the gist of the invention are intended to be within the scope of the invention.

What is claimed is:

1. A holographic product labeling method, comprising:
defining a holographic image having content adapted to convey information relating to a product;
providing a substrate encoded with a hologram adapted to render the holographic image; and
labeling the product with the substrate.

2. The method of claim 1, wherein said defining a holographic image includes selecting the content of the image to increase visual appeal by decreasing intrusion of required information upon a consumer.

3. The method of claim 1, wherein said defining a holographic image includes selecting the content of the image to increase amount of required information communicated to a consumer via a given area of the substrate.

4. The method of claim 1, wherein said defining a holographic image includes selecting the content of the image to convey information relating to identity of the product.

5. The method of claim 1, wherein said defining a holographic image includes selecting the content of the image to convey information relating to identity of a manufacturer of the product.

6. The method of claim 1, wherein said defining a holographic image includes selecting the content of the image to convey information relating to identification of a use of the product.

7. The method of claim 1, wherein said defining a holographic image includes selecting the content of the image to convey information relating to identification of a feature of the product.

8. The method of claim 1, wherein said defining a holographic image includes selecting the content of the image to convey information relating to identification of a characteristic of the product.

9. The method of claim 1, wherein said defining a holographic image includes selecting the content of the image to convey information relating to instructions for using the product.

10. The method of claim 1, wherein said defining a holographic image includes selecting the content of the image to convey information relating to identification of product ingredients.

11. The method of claim 1, wherein said defining a holographic image includes selecting the content of the image to convey information relating to safety precautions applicable to use of the product.

12. The method of claim 1, wherein said defining a holographic image includes selecting the content of the image to convey information relating to legal notices binding a user of the product.

13. The method of claim 1, wherein said providing a substrate encoded with a hologram adapted to render the holographic image includes providing a substrate encoded with a hologram adapted to render multiple holographic images viewable from different angles.

14. The method of claim 1, wherein said providing a substrate encoded with a hologram adapted to render the holographic image includes providing a substrate encoded with a hologram adapted to render multiple holographic images of substantially identical content from substantially different perspectives, thereby achieving a three-dimensional appearance for a seemingly still image.

15. The method of claim 1, wherein providing a substrate encoded with a hologram adapted to render the holographic image includes providing a substrate encoded with a hologram adapted to render multiple holographic images of substantially different content, but substantially similar subject matter, thereby achieving an animation effect using the multiple images.

16. The method of claim 1, wherein said providing a substrate encoded with a hologram adapted to render the holographic image includes providing a substrate encoded with a hologram adapted to render multiple holographic images of substantially different content, and substantially different subject matter, thereby increasing an amount of information communicated to a consumer via a given area of the substrate.

17. The method of claim 1, wherein said providing a substrate encoded with a hologram adapted to render the holographic image includes providing a substrate encoded with a true hologram adapted to render the holographic image.

18. The method of claim 1, wherein said providing a substrate encoded with a hologram adapted to render the holographic image includes providing a substrate encoded with a multiplex hologram adapted to render the holographic image.

19. The method of claim 1, wherein said providing a substrate encoded with a hologram adapted to render the holographic image includes providing a substantially transparent substrate encoded with the hologram.

20. The method of claim 1, wherein said providing a substrate encoded with a hologram adapted to render the holographic image includes providing a substantially opaque substrate encoded with the hologram.

21. The method of claim 1, wherein said labeling the product with the substrate includes attaching the substrate to the product.

22. The method of claim 1, wherein said labeling the product with the substrate includes attaching the substrate to a product label relating to the product.

23. The method of claim 1, wherein said labeling the product with the substrate includes attaching a substantially transparent substrate encoded with the hologram to a substantially opaque label relating to the product.

24. The method of claim 1, wherein said labeling the product with the substrate includes attaching a substantially transparent substrate encoded with the hologram to a substantially opaque label bearing visually appealing designs selected to increase visual appeal of the product.

25. The method of claim 1, wherein said labeling the product with the substrate includes attaching a substantially transparent substrate encoded with the hologram to a substantially opaque label bearing information relating to the product.

26. The method of claim 1, wherein said labeling the product with the substrate includes attaching the substrate to a product container.

27. The method of claim 1, wherein said labeling the product with the substrate includes substantially permanently attaching the substrate.

28. The method of claim 1, wherein said labeling the product with the substrate includes temporarily attaching the substrate, wherein the substrate is a capable of being peeled by a consumer.

29. The method of claim 1, wherein said labeling the product with the substrate includes temporarily attaching the substrate, wherein the substrate is a capable of being peeled by a consumer and at least temporarily reattached to a surface selected by the consumer.

30. The method of claim 1, comprising encoding the substrate with the hologram.

31. The method of claim 1, comprising providing a scent dispenser to the product adapted to dispense a scent selected to communicate a product characteristic.

32. The method of claim 1, comprising providing a holographic appropriate light source to the product.

33. The method of claim 1, comprising displaying a labeled product to consumers.

34. The method of claim 1, comprising displaying a labeled product to consumers in a retail environment.

35. The method of claim 1, comprising providing holographic appropriate lighting in a retail environment, thereby improving display of a labeled product to consumers in the retail environment.
